(19) United States
(12) Patent Application Publication
(10) Pub. No.: US 2020/0305447 A1
(43) Pub. Date: Oct. 1, 2020

(54) System and Method for Preparing a Croissant Toast

(71) Applicant: Shaw Bakers LLC, San Francisco, CA (US)

(72) Inventors: Pascal Rigo, San Francisco, CA (US); Nicolas Bernadi, Redwood Shores, CA (US); Stephane Stocki, San Francisco, CA (US)

(73) Assignee: Shaw Bakers LLC, Redwood Shores, CA (US)

(21) Appl. No.: 16/838,002

(22) Filed: Apr. 1, 2020

Related U.S. Application Data
(60) Provisional application No. 62/827,523, filed on Apr. 1, 2019.

(51) Int. Cl. A21D 17/00; A21B 3/13

(52) U.S. Cl. CPC A21D 17/004; A21B 3/133

(57) ABSTRACT

A novel loaf shaped croissant suitable for slicing and the individual slices suitable for toasting.

### BACKGROUND

The croissant is a very well-known pastry, having characteristics of being light and flaky with a “trademark” appearance and size. However, as a form of bread it does not lend itself well to toasting (the crust flaking within the toaster) and is not well suited for the standard sandwich (being of an oblong or crescent shape).

### SUMMARY

In view of this, the inventor(s) have developed a novel way to preserve the texture and flakiness characteristics of a croissant while having the bread form the desired shape of a loaf. This is accomplished by arranging individual croissants in a pre-determined configuration within a loaf-shaped bread pan. The arrangement results in the individual croissants merging together and rising upward (more so than if the croissants were baked individually) to form a tall loaf—thus, being suitable for slicing for toast or standard shaped sandwiches.

### BRIEF DESCRIPTION OF THE DRAWINGS

The novel features of the disclosure are set forth in the appended claim(s). However, for purpose of explanation, several embodiments are illustrated in the following drawings.

FIG. 1 illustrates the on-shelf characteristics of a loaf of Croissant Toast manufactured according to an exemplary embodiment;

FIG. 2 illustrates the visual and physical characteristics of the Croissant Toast;

FIG. 3 illustrates the formula and ingredients of the Croissant Toast;

FIG. 4 illustrates the allergen statement; ingredient claims and preparation instructions of the Croissant Toast;

FIG. 5 illustrates the safety assessment, packaging description and Lug configuration of the Croissant Toast;

FIG. 6 illustrates the storage and transportation of the Croissant Toast;

FIG. 7 illustrates the finish product requirements of the Croissant Toast;

FIG. 8 illustrates the initial first two steps in the procedures bench of the Croissant Toast;

FIG. 9 illustrates the next two steps in the procedures bench of the Croissant Toast;

FIG. 10 illustrates the remaining four steps in the procedures bench of the Croissant Toast;

FIG. 11 illustrates the proofing step in the procedures bench of the Croissant Toast;

FIG. 12 illustrates the baking procedure for the Croissant Toast;

FIG. 13 illustrates the target outside color of the Croissant Toast;

FIG. 14 illustrates the target inside color of the Croissant Toast;

FIG. 15 illustrates the target inside and outside look of the sliced loaf of Croissant Toast.

### DETAILED DESCRIPTION

The approach(es) used by the inventors is shown in the accompanying figures and description. It is noted that while the embodiments shown have a single layer of croissants, it is envisioned that an interleaving layer may be implemented (e.g., on top of and bridging adjoining croissants) to provide a much taller loaf. Also, it is understood that the croissants do not necessarily have to be similarly shaped or similarly sized, to achieve the desired results. For example, smaller croissants may be placed between larger croissants, and the orientation of the croissants within the bread pan may be reversed, or alternated, according to design preference. Further, it is understood that once the ability to create a croissant loaf is made evident, other loaf shape(s) and sizes can be developed using the principles shown herein. Therefore, various changes and modifications to the arrangements shown may be made by one of ordinary skill in the art without departing from the spirit and scope of this disclosure.

The foregoing relates to illustrative details of exemplary embodiments and modifications may be made without departing from the scope of the disclosure as defined by the following claims.

I claim:

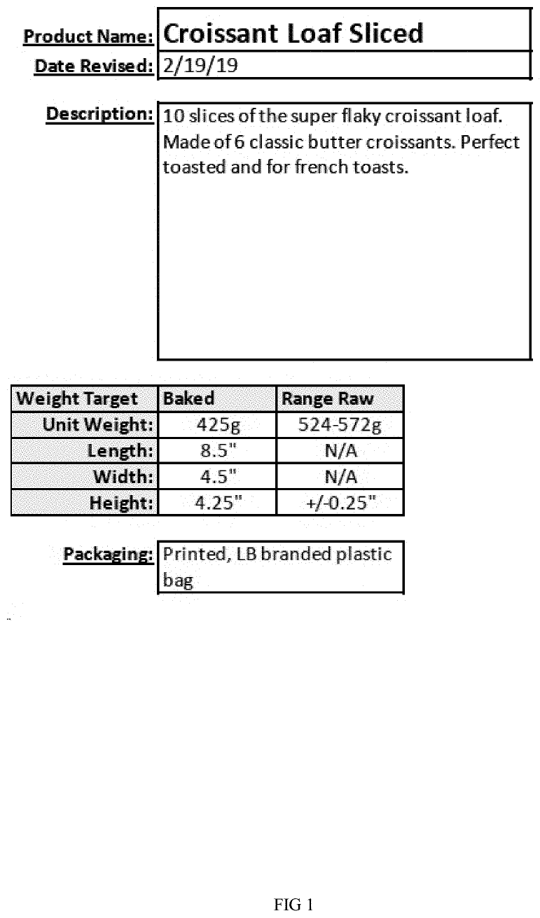

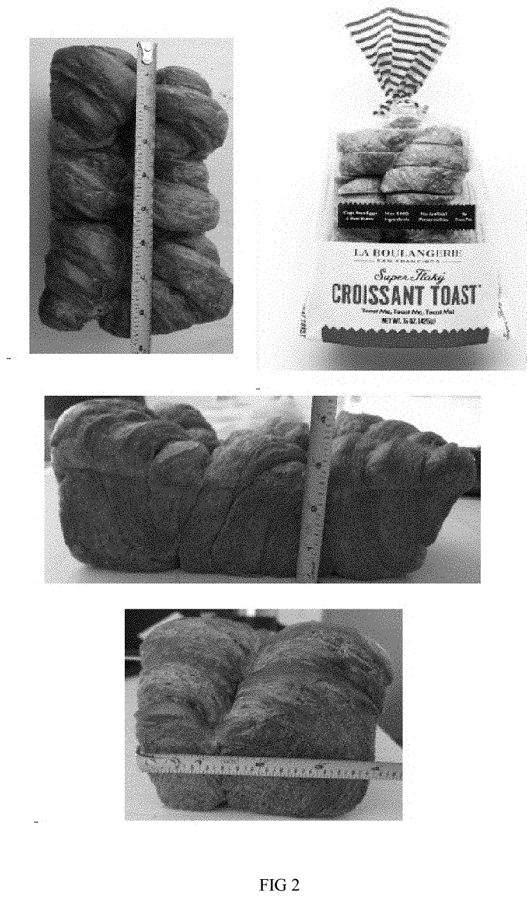

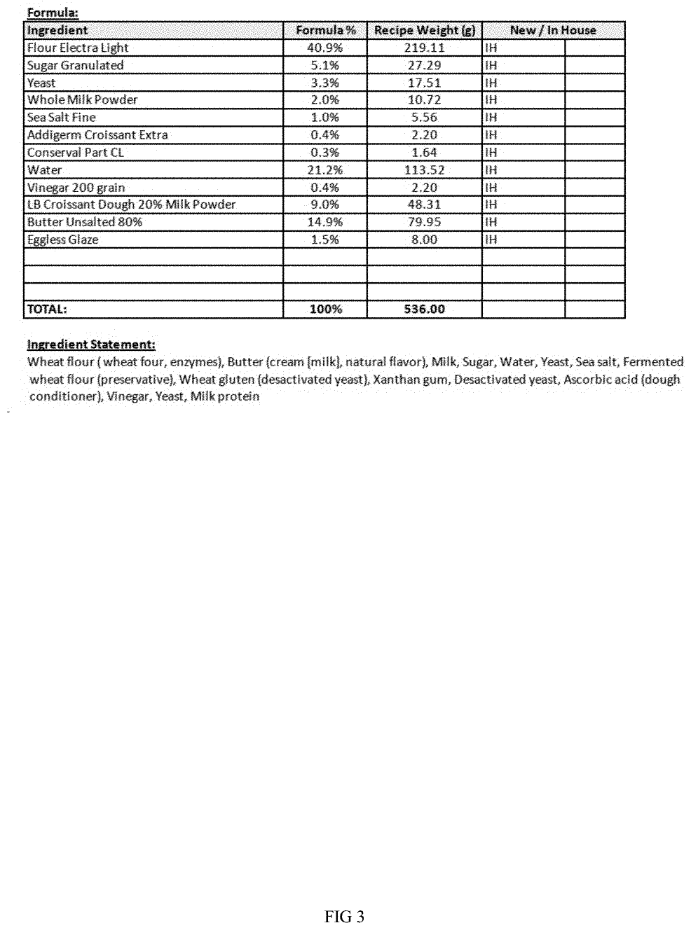

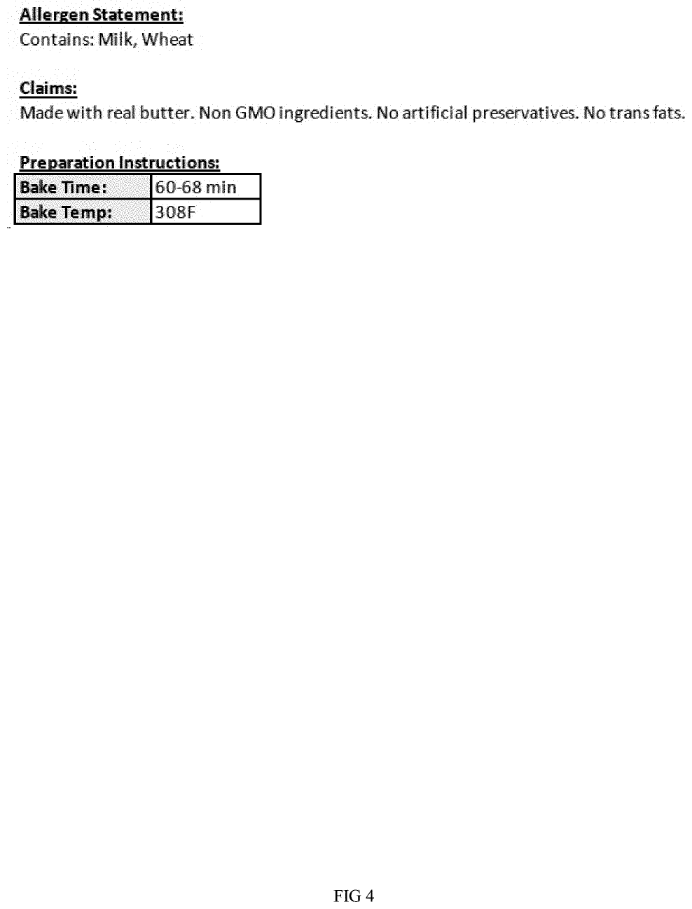

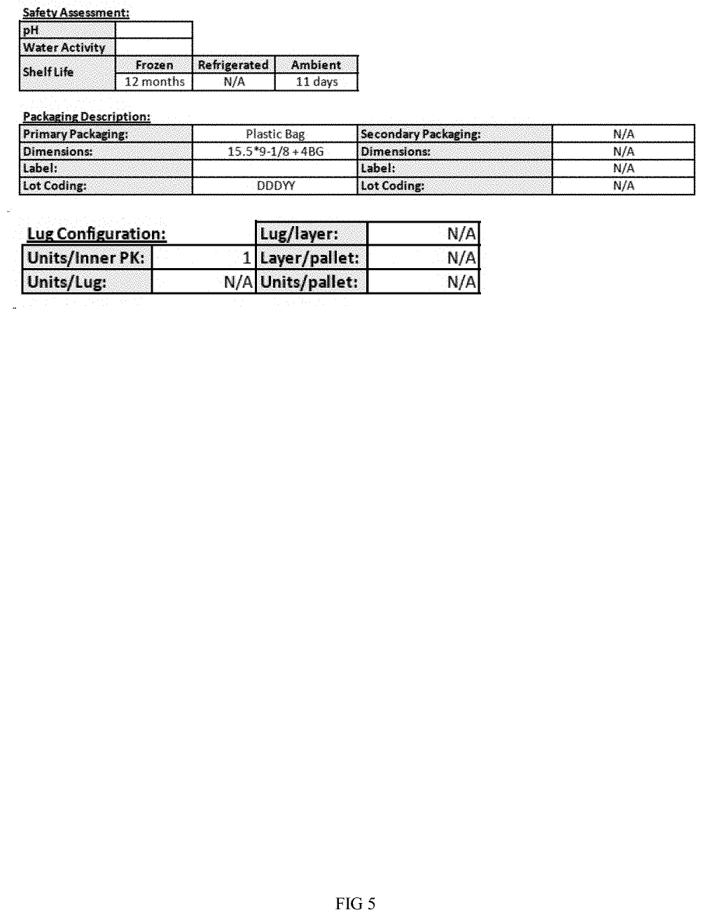

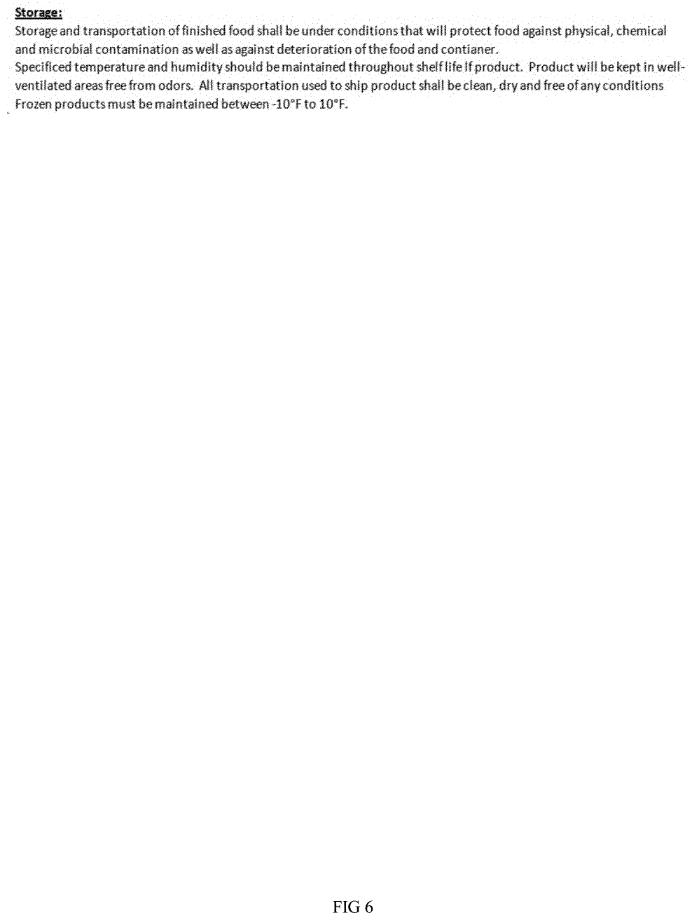

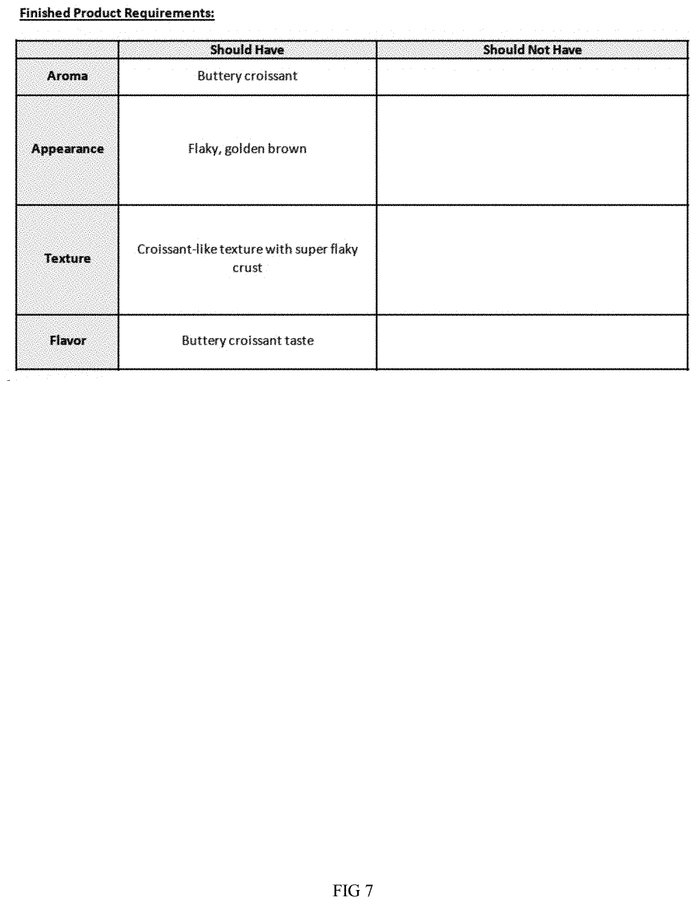

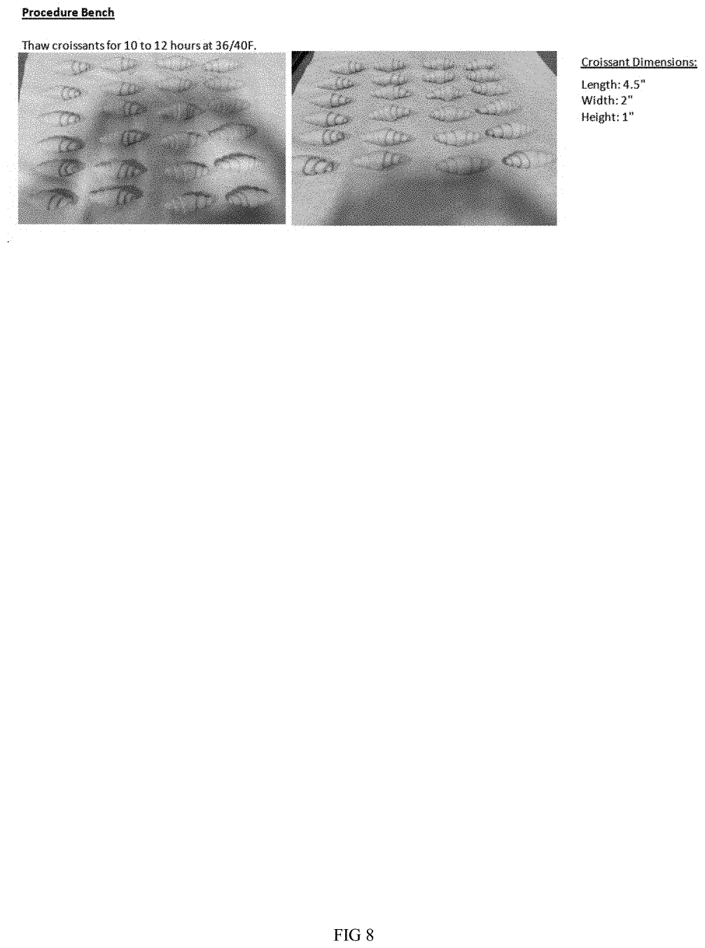

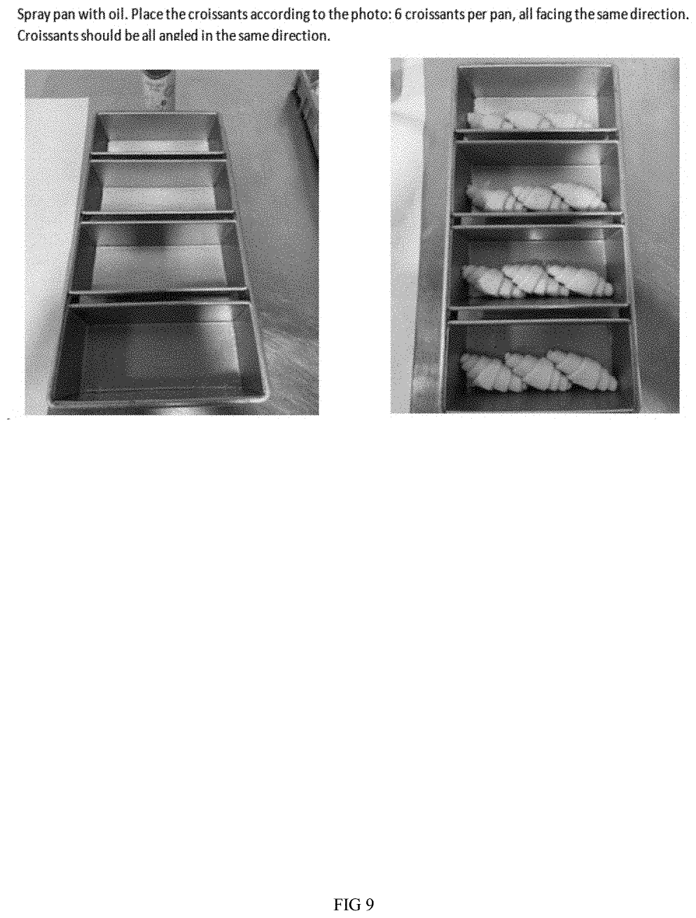

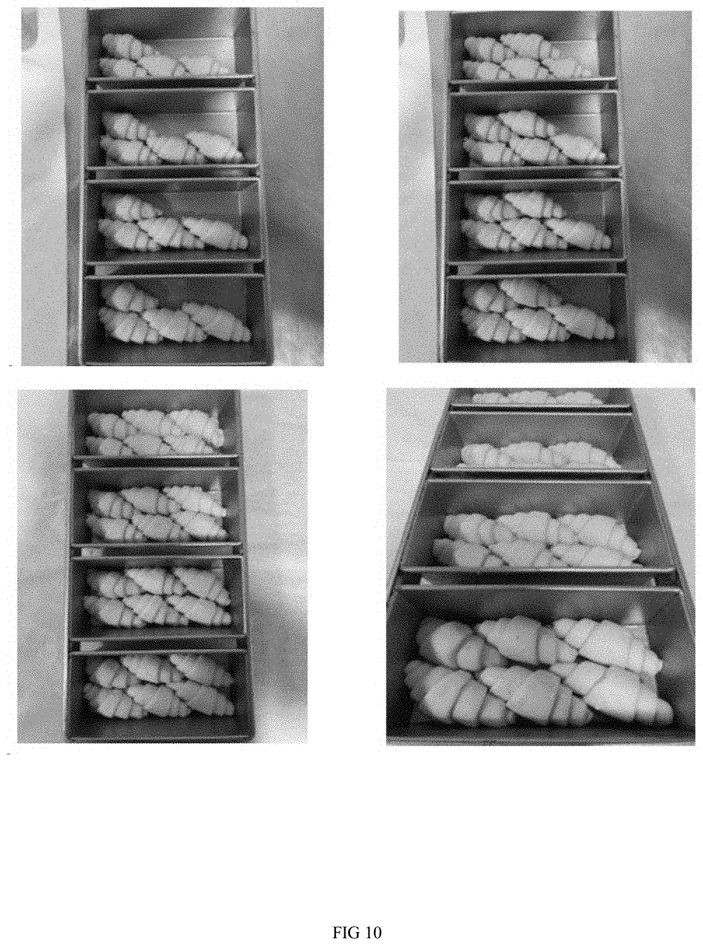

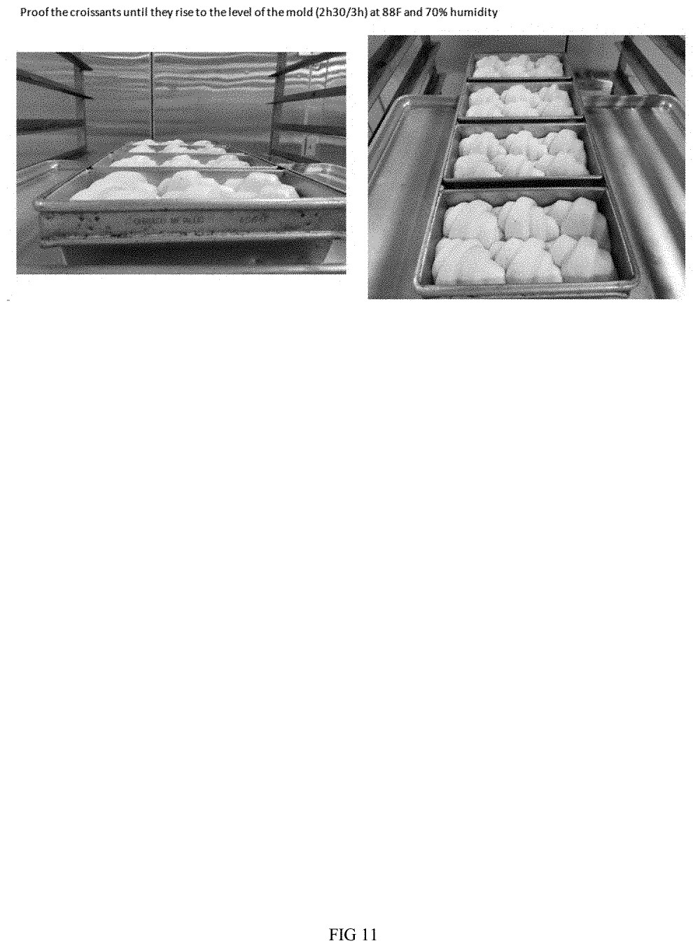

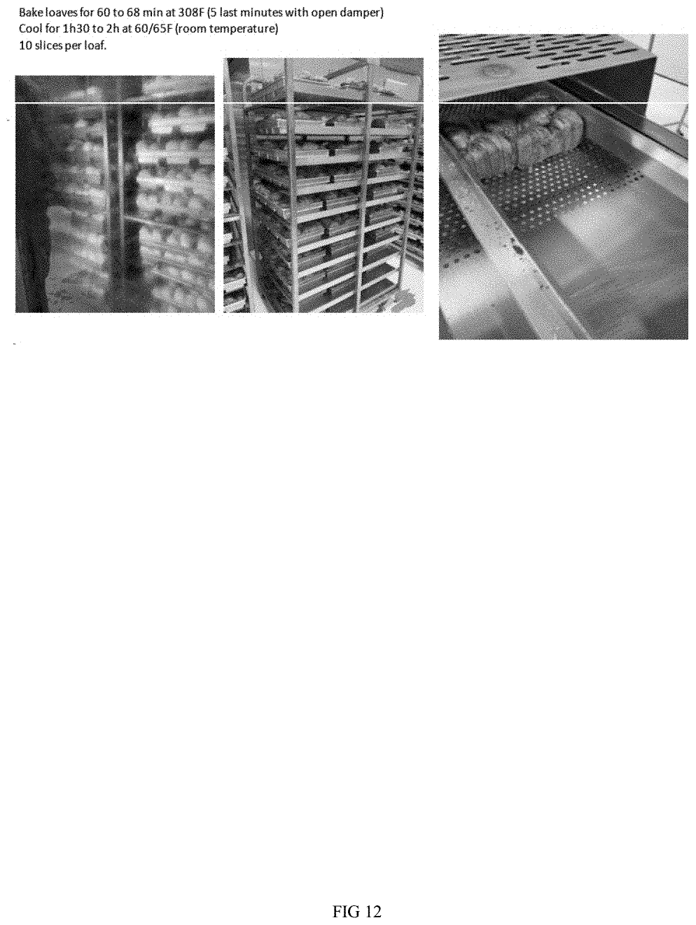

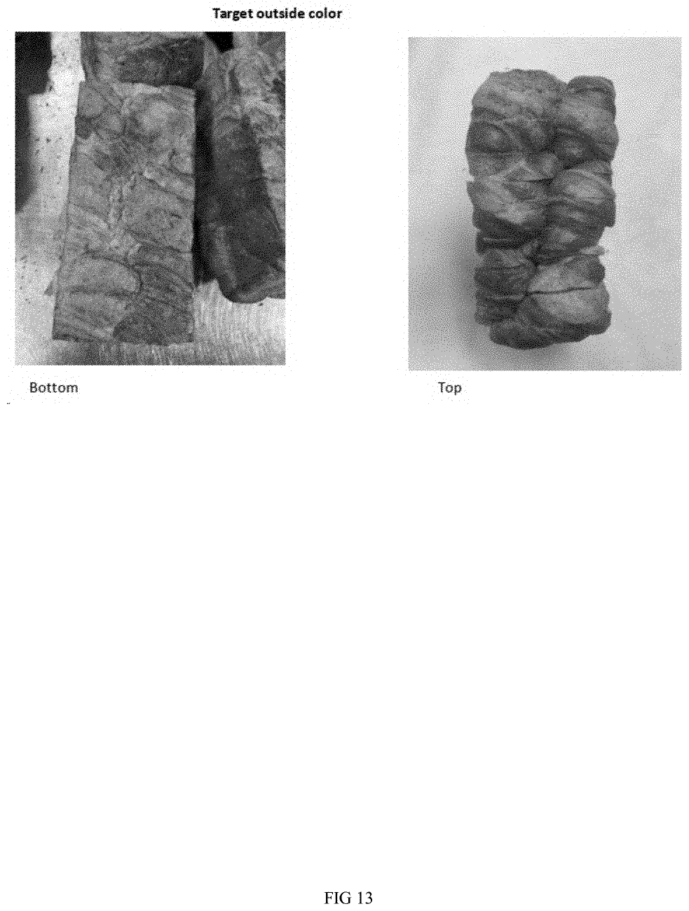

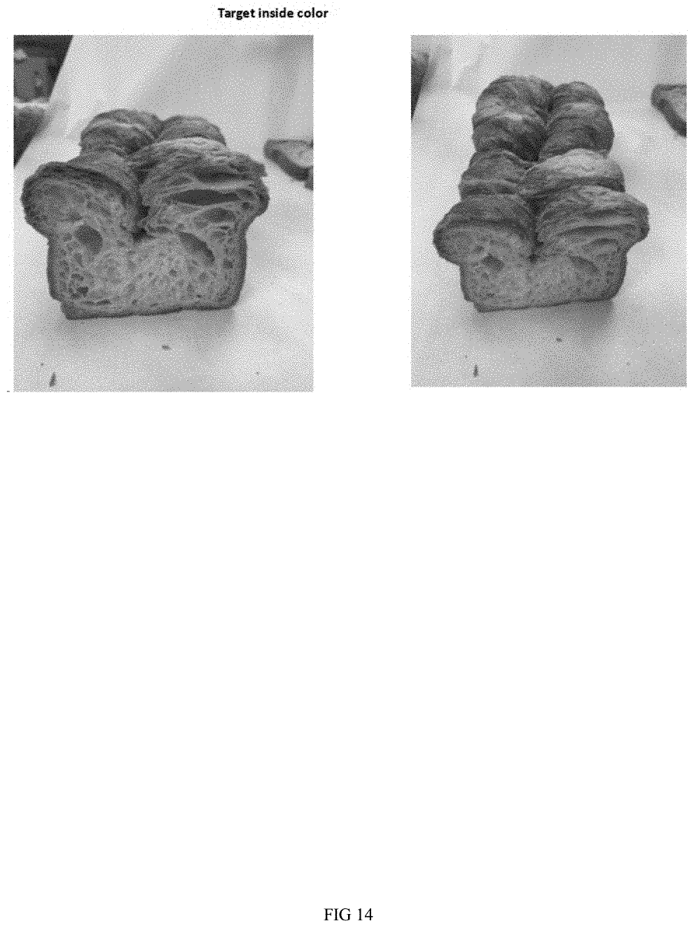

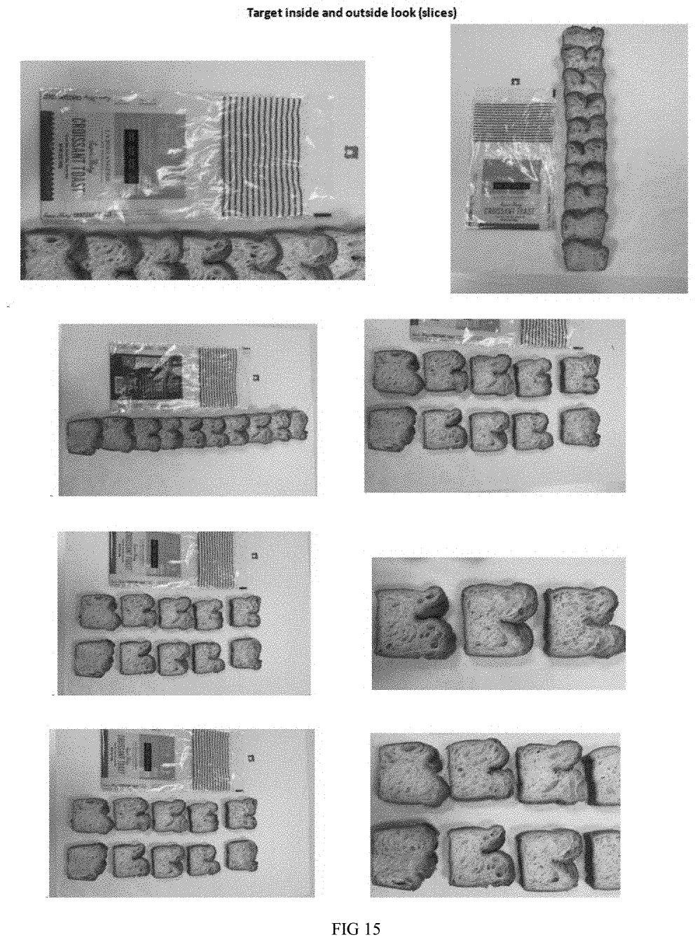

1. A method and system of manufacturing a croissant toast loaf from an arrangement of individual croissants and baking the arrangement as set forth in FIGS. 1 through 15.

2. A croissant toast loaf manufactured from an arrangement of individual croissants as baked according to the arrangement as set forth in FIGS. 1 through 15.
